(19) United States
(12) Patent Application Publication
(10) Pub. No.: US 2026/0178295 A1
(43) Pub. Date: Jun. 25, 2026

(54) CONTEXT-AWARE INLINING BASED ON HYBRID PROFILING

(71) Applicant: Oracle International Corporation, Redwood Shores, CA (US)

(72) Inventors: Maja VUKASOVIC, Belgrade (RS); Boris SPASOJEVIC, Zurich (CH); Aleksandar PROKOPEC, Zurich (CH)

(73) Assignee: Oracle International Corporation, Redwood Shores, CA (US)

(21) Appl. No.: 18/988,148

(22) Filed: Dec. 19, 2024

(51) Int. Cl. G06F 8/41

(52) U.S. Cl. CPC G06F 8/43

(57) ABSTRACT

A method implements generating a sampling profile and an instrumentation profile from source code. The method involves identifying a hot subroutine from the source code with the sampling profile. The method further involves executing a hot modifier process with the hot subroutine and one or more of the sampling profile and the instrumentation profile to generate a hot compilation unit. The method further involves executing a cold modifier process with a cold subroutine from the source code and the instrumentation profile to generate a cold compilation unit. The method further involves incorporating the hot compilation unit and the cold compilation unit into a modified compilation schedule.

### BACKGROUND

Profile guided optimization collects data during execution of a program to generate profiles that may be used to guide the process of generating modifications to optimize aspects of the executable code that form the program. Profiles that may be used include sampling profiles and instrumentation profiles.

Sampling profiles may be generated by periodically collecting snapshots of the function call stack during execution of the program. Sampling profiles may include program locations that are active on the call stack during the profile collection, starting from the entry point of the program, and are context sensitive. Calling contexts from the entries in the profile are associated with the number of times each context was recorded during the execution of the program. Challenges with using sampling profiles for profile guided optimization include the under representation of infrequently executed code as well as the inability to capture certain performance characteristics of the program, which may lead to modifications that do not properly optimize the program.

Instrumentation profiles may be generated by inserting snippets of code into the program being profiled to collect information of the performance characteristics of the program during execution. The snippets may measure and record the run-time properties of the respective parts of the program. The use of instrumentation profiles for profile guided optimization may be challenging. The process of inserting instrumentation code (the snippets) into the program may slow down execution of the program, which may distort the profiling data by affecting the run-time behavior. The increased code size due to the instrumentation code may lead to higher memory usage and cache misses, further impacting performance of the program. Collecting detailed profiling data through instrumentation may introduce overhead making it infeasible for large-scale applications or complex programs. The process of gathering and analyzing the profiling data can be time-consuming and resource-intensive, potentially complicating the development workflow and delaying optimizations.

### SUMMARY

In general, in one or more aspects, the disclosure relates to a method for generating a sampling profile and an instrumentation profile from source code. The method involves identifying a hot subroutine from the source code with the sampling profile. The method further involves executing a hot modifier process with the hot subroutine and one or more of the sampling profile and the instrumentation profile to generate a hot compilation unit. The method further involves executing a cold modifier process with a cold subroutine from the source code and the instrumentation profile to generate a cold compilation unit. The method further involves incorporating the hot compilation unit and the cold compilation unit into a modified compilation schedule.

In general, in one or more aspects, the disclosure relates to a system that includes at least one processor and an application that executes on the at least one processor. Executing the application performs generating a sampling profile and an instrumentation profile from source code. Executing the application further performs identifying a hot subroutine from the source code with the sampling profile. Executing the application further performs executing a hot modifier process with the hot subroutine and one or more of the sampling profile and the instrumentation profile to generate a hot compilation unit. Executing the application further performs executing a cold modifier process with a cold subroutine from the source code and the instrumentation profile to generate a cold compilation unit. Executing the application further performs incorporating the hot compilation unit and the cold compilation unit into a modified compilation schedule.

In general, in one or more aspects, the disclosure relates to a non-transitory computer readable medium including instructions executable by at least one processor. Executing the instructions performs generating a sampling profile and an instrumentation profile from source code. Executing the instructions further performs identifying a hot subroutine from the source code with the sampling profile. Executing the instructions further performs executing a hot modifier process with the hot subroutine and one or more of the sampling profile and the instrumentation profile to generate a hot compilation unit. Executing the instructions further performs executing a cold modifier process with a cold subroutine from the source code and the instrumentation profile to generate a cold compilation unit. Executing the instructions further performs incorporating the hot compilation unit and the cold compilation unit into a modified compilation schedule.

Other aspects of one or more embodiments may be apparent from the following description and the appended claims.

### BRIEF DESCRIPTION OF DRAWINGS

FIG. 1 show a diagram in accordance with the disclosure.

FIG. 2 shows a method in accordance with the disclosure.

FIG. 3, FIG. 4A, FIG. 4B, FIG. 4C, FIG. 5A, FIG. 5B, and FIG. 6 show examples in accordance with the disclosure.

FIG. 7A and FIG. 7B show computing systems in accordance with the disclosure.

Similar elements in the various figures are denoted by similar names and reference numerals. The features and elements described in one figure may extend to similarly named features and elements in different figures.

### DETAILED DESCRIPTION

One or more embodiments of the disclosure may address the challenges of using sampling profiles and instrumentation profiles by compilers for profile guided optimization. Hybrid profiling may be implemented by collecting both sampling profiles and instrumentation profiles and using different combinations of the profiles when modifying the code to improve performance characteristics of the code (i.e., to optimize the code). For example, each subroutine from a program may be analyzed to determine if the subroutine is a hot subroutine (e.g., frequently called) or a cold subroutine (e.g., not frequently called). Hot subroutines may be modified more aggressively trading size for increased performance based at least on the sampling profile. Cold subroutines may be modified more conservatively trading performance for reduced size based on the instrumentation profile.

Additionally, the sampling profiles, being fully-context sensitive, i.e., capturing samples of the entire program call stack, may be used to compile duplicates of the same subroutines multiple times, once for each calling context. Different duplicates of the same subroutine may be modified independently and with different profiles, depending on the context of their invocation in the program. The duplicated compilation units generated by the duplication may be individually modified to further improve program performance.

Profiles may be used in multiple ways. Profiles may be used to identify the frequently executed and long-running subroutines (referred to as the hot subroutines). A subroutine may be “frequently executed” or “long-running” and referred to as “hot” when the subroutine appears in a set of sampled call stacks above a threshold value above a threshold value or percentage (e.g., 10 percent of recorded or sampled call stacks include the subroutine). Such a subroutine may be considered “long-running” because the time spent executing that subroutine may exceed a threshold value or percentage of total execution time (e.g., 10 percent of total execution time of the program). Call stacks that frequently occur in the sampling profiles refer to code that contribute to the total time spent in the program. A specific threshold percentage may be used to decide which call stacks are preserved and which are not preserved.

Profiles may be used to specialize different compilation units that correspond to the same hot subroutine when invoked from different calling contexts. Subroutines are duplicated to create specialized compilation units and modify the duplicates differently depending on the calling context.

Profiles may be used to improve the inlining modifications in the duplicated hot compilation units. An inliner may perform a cost-benefit analysis using a predetermined inlining threshold to determine when to perform a modification (e.g., to inline a call to a subroutine). The inlining threshold of a duplicated hot compilation unit may be an aggressive threshold that increases the likelihood for the compiler to modify those compilation units. Much of the program execution time may be spent in hot compilation units, so using an aggressive threshold (which makes compiler optimizations more frequent) is applied to parts of the program where the performance impact is noticeable. Furthermore, in a duplicated hot compilation unit, the inliner uses profiles that correspond to the calling contexts of that compilation unit. The profiles that correspond to a specific calling context are less polluted and more specific, allowing the inliner to make better inlining decisions. For example, the inliner may decide to inline callee subroutines in which most of the execution time of the program is spent.

Profiles may be used to reduce the number of indirect calls in the modified executable code output from the compiler. Applying calling-context-specific profiles to duplicated hot compilation units increases the ability of the inliner to devirtualize indirect calls (i.e., perform polymorphic inlining). By assigning calling-context-specific call-target profiles to each callsite of the duplicated hot compilation unit, callsites in those hot compilation units may be replaced with direct calls.

Profiles may be used to improve the inlining optimization in the compilation units that are not frequently executed (e.g., cold compilation units). For the cold compilation unit, one compilation unit may be maintained for cold calling contexts of the same subroutine. Therefore, the inlining optimization may exploit partially-context-sensitive profiles obtained by instrumentation-based profiling.

Profiles may be used to decrease the generated code size. The cold parts of the program use conservative thresholds decisions to make modifications. Using conservative thresholds may decrease the binary size of the program because fewer modifications (which may increase code size, such as loop peeling and unrolling, loop unswitching, path duplication, etc.) are applied in the cold subroutines of the program. Using conservative thresholds for cold parts of the program is effective because cold parts of the program may include a large percentage of the source code that defines the program. At the same time, using conservative thresholds in for the cold parts does not decrease performance because a small amount of execution time is spent in the cold parts of the program.

The compilation of a hot subroutine when invoked from one calling context, may be distinguished from the compilation of that same hot subroutine when invoked from different calling contexts. If multiple frequently executed calling contexts invoke a subroutine, duplicating a subroutine in all its frequent calling contexts (i.e., duplicating it multiple times) may be beneficial. The subroutine may exhibit different behavior for any of its calling contexts. Duplicating a subroutine at each calling context (including the rarely executed ones) may not be feasible, due to the overhead in compiled code. To prevent the increase of compiled code size, the subroutines may be selectively duplicated based on frequency of use.

The computing system (101) is a collection of hardware and software components that implement context-aware inlining based on hybrid profiling. The computing system (101) includes at least one processor and memory storing data and programs that execute on the processor. The computing system (101) processes the source code (103) to generate modified executable code (155), offering practical application and improvements over prior systems by optimizing program execution and reducing binary size through context-sensitive profiling and inlining techniques. A context within the computing system (101) may be the specific state and environment in which a subroutine operates, which may include the current values of variables, call stacks, processor registers, memory allocations, etc., that define the execution state at a particular point in time. Although shown as monolithic, the system (101) may be distributed with the hardware and software components operating on multiple computing systems.

The source code (103) is the initial input used in the computing system (101) for generating executable programs. The source code (103) includes a set of instructions and functionalities that describe the desired operations and behaviors of an application. The source code (103) may be written in a programming language such as Java, Python, C, C++, etc. The source code (103) may be input to the compiler A (105) and the compiler B (121).

The compiler A (105) is a component that processes the source code (103) to generate the executable code (109) and the compilation schedule (107) in an initial compilation process. The compiler A (105) receives the source code (103) as input and compiles the source code (103) into a format suitable for execution on a computing system. The compilation process may include translating the high-level instructions of the source code (103) into machine code or an intermediate representation. The compiler A (105) may include hooks and collection routines in the executable code (109) that may be used to collect information for the sampling profile (113) and the instrumentation profile (115). The output of the compiler A (105) includes the compilation schedule (107), which outlines the order and manner in which the code should be compiled, and includes the executable code (109), which is an executable version of the source code (103).

The compilation schedule (107) is an output generated by the compiler A (105) during an initial compilation process. The compilation schedule (107) provides a structured plan for the compilation process, detailing the sequences and tasks to compile the parts of the source code (103). The compilation schedule (107) is used by the compiler A (105) to define and perform the compilation process for the source code (103) to generate the executable code (109).

The executable code (109) is the product of the compilation process performed by the compiler A (105). The executable code (109) represents the compiled version of the source code (103), translated into a format that can be executed by a computing system. The executable code (109) is a direct output of the compiler A (105) and may be an initial version of the program defined by the source code (103). The executable code (109) may include hooks and collection routines and be executed to gather in profiling information for the sampling profile (113) and the instrumentation profile (115).

The profile generator (111) creates hybrid profiles from the executable code (109). The profile generator (111) processes the executable code (109) to collect run-time data and generate profiles that include the sampling profile (113) and the instrumentation profile (115). The profile generator (111) may operate by executing the executable code (109) and capturing various run-time characteristics through sampling and instrumentation techniques.

The sampling profile (113) is a type of profile generated by the profile generator (111). The sampling profile (113) is created by periodically sampling the call stack during the execution of the executable code (109). The sampling profile (113) captures snapshots of the program's call stack at specific intervals, providing a context-sensitive view of the execution of the program. The sampling profile (113) may identify frequently executed subroutines and execution paths, which may be used for making optimization decisions. The sampling profile (113) may be output from the profile generator (111) and input to the compiler B (121) for further processing and optimization.

The instrumentation profile (115) is another type of profile generated by the profile generator (111). The instrumentation profile (115) is created by inserting additional code snippets that form hooks and collection routines into the source code (103) to record run-time properties during the execution of the executable code (109). The instrumentation profile (115) includes execution data, such as the frequency of specific events and the run-time behavior of different parts of the code. The instrumentation profile (115) may be used for optimizing subroutines that are not frequently executed but still impact the overall performance and size of the program defined by the source code (103). The instrumentation profile (115) may be output from the profile generator (111) and used in conjunction with the sampling profile (113) by the compiler B (121) to generate the modified executable code (155).

The compiler B (121) is a component that may modify the source code (103) and generate the modified executable code (155). The compiler B (121) may be the same compiler as the compiler A (105) operating in a different mode or phase to modify (e.g., optimize) the source code (103). The compiler B (121) processes the source code (103) in different stages or phases to enhance performance and reduce the size of the modified executable code (155). The hot modifier (137) processes the hot subroutines (135) with the sampling profile (113) to generate the hot compilation units (139). The hot modifier (137) may also process the hot subroutines (135) with one or more of the instrumentation profile (115) and a synthetic instrumentation profile to generate the hot compilation units (139). The compiler B (121) may include the compiler frontend (123), the compiler middle-end (131), and the compiler backend (153), which are used to process the source code (103) with the sampling profile (113) and the instrumentation profile (115) to generate the modified executable code (155).

The compiler frontend (123) is a portion of the compiler B (121). The compiler frontend (123) may process the source code (103) to generate a control flow graph and identify the subroutines (125). The control flow graph includes blocks that may represent the subroutines (125) extracted from the source code (103). The compiler frontend (123) receives the source code (103) as input and outputs the identified subroutines (125) to the hot classifier (133) within the compiler middle-end (131).

The subroutines (125) are distinct sections of the source code (103) that may represent individual functions or methods within the program defined by the source code (103). The subroutines (125) may be identified and extracted by the compiler frontend (123). The subroutines (125) are input to the hot classifier (133).

The compiler middle-end (131) is a portion of the compiler B (121) that processes the subroutines (125) to generate the modified compilation schedule (151). The compiler middle-end (131) includes the hot classifier (133), the hot modifier (137), and the cold modifier (147). The component of the compiler middle-end (131) operate together to classify subroutines as hot or cold, apply optimizations accordingly, and combine the results into the modified compilation schedule (151). The compiler middle-end (131) outputs the modified compilation schedule (151), which may be processed by the compiler backend (153).

The hot classifier (133) is a component within the compiler middle-end (131) that evaluates the subroutines (125) to classify the subroutines (125) as hot (i.e., the hot subroutines (135)) or cold (i.e., the cold subroutines (145)). The classification may be based on profiling data from the sampling profile (113). The hot classifier (133) uses the sampling profile (113) to determine which subroutines are executed frequently (hot) and which are not (cold). The output of the hot classifier (133) may include the hot subroutines (135) and the cold subroutines (145). The hot classifier (133) may use a hot threshold to identify the hot subroutines (135) from the cold subroutines (145) within the subroutines (125).

The hot subroutines (135) may be subroutines from the subroutines (125) identified by the hot classifier (133) as frequently executed or “hot”. The hot subroutines (135) may be input to the hot modifier (137) for aggressive modification.

The hot modifier (137) may be an optimizer component within the compiler middle-end (131) that processes the hot subroutines (135). The hot modifier (137) uses the sampling profile (113) and may use the instrumentation profile (115) or a synthetic instrumentation profile, with an aggressive threshold to generate modifications to the hot subroutines (135). The aggressive threshold may be lower than the conservative threshold used by the cold modifier (147). The synthetic instrumentation profile may be a version of an instrumentation profile generated from the sampling profile (113) instead of from executing the executable code (109). The hot modifier (137) may make modifications to the source code (103), or intermediate representations thereof, and operate to reduce run time or size of the modified executable code (155). The hot modifier (137) outputs the hot compilation units (139).

The hot compilation units (139) are the output of the hot modifier (137). The hot compilation units (139) may represent aggressively modified versions of the hot subroutines (135). The hot compilation units (139) form part of the modified compilation schedule (151).

A compilation unit (e.g., one of the hot compilation units (139) or one of the cold compilation units (149)) may be a distinct portion of the source code (103) that is treated as a single entity by the compiler B (121) during a compilation process. A compilation unit may include a source file from the source code (103) that contains code, such as functions, methods, and variable declarations, that the compiler B (121) processes together to generate machine code or intermediate code. A compilation unit may be a file that contains one or more definitions or declarations that the compiler translates into an object file or other intermediate form. Compilation units may be used to organize code and manage dependencies, as each unit may be compiled independently before being linked together with other units to form the output executable program.

The cold subroutines (145) are subroutines identified within the subroutines (125) that are not frequently executed. The hot classifier (133) classifies these subroutines as cold based on profiling data from the sampling profile (113). The cold subroutines (145) are input to the cold modifier (147) for further processing. The cold subroutines (145) are intended for conservative modification to minimize the overall size of the final executable code.

The cold modifier (147) may be an optimizer component of the compiler middle-end (131) that modifies the cold subroutines (145). The cold modifier (147) may use a conservative threshold to generate modifications to the cold subroutines (145), guided by the instrumentation profile (115). The cold modifier (147) may reduce the size of the cold subroutines (145) without significantly impacting the performance of the cold subroutines (145). The cold modifier (147) outputs the cold compilation units (149), which may be modified versions of the cold subroutines (145).

The cold compilation units (149) are the output of the cold modifier (147). The cold compilation units (149) represent the conservatively modified versions of the cold subroutines (145). The cold compilation units (149) form part of the modified compilation schedule (151).

The modified compilation schedule (151) is a structured plan that outlines the order and manner in which the hot compilation units (139) and the cold compilation units (149) are compiled to form the modified executable code (155). The modified compilation schedule (151) may be different form the compilation schedule (107) using different tasks or sequences to compile the subroutines (125) into the modified executable code (155). The modified compilation schedule (151) may include the hot compilation units (139) and the cold compilation units (149). The modified compilation schedule (151) is output from the compiler middle-end (131) and input to the compiler backend (153).

The compiler backend (153) is a component that processes the modified compilation schedule (151) to generate the modified executable code (155). The compiler backend (153) may translate instructions from the hot compilation units (139) and the cold compilation units (149) into machine code or an intermediate representation that may be executable by a computing system. The output of the compiler backend (153) is the modified executable code (155).

The modified executable code (155) is the output generated from the source code (103) after being modified. The modification may reduce the run-time of the hot subroutines (135) and reduce the size of the cold subroutines (145). The modified executable code (155) may represent a compiled and optimized version of the source code (103), incorporating improvements made through context-aware inlining and hybrid profiling.

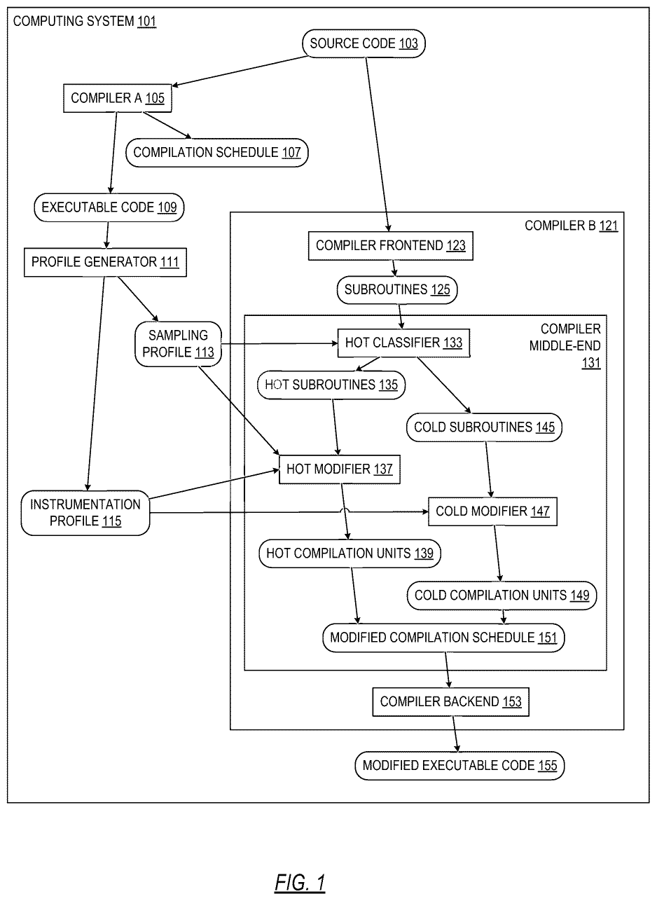

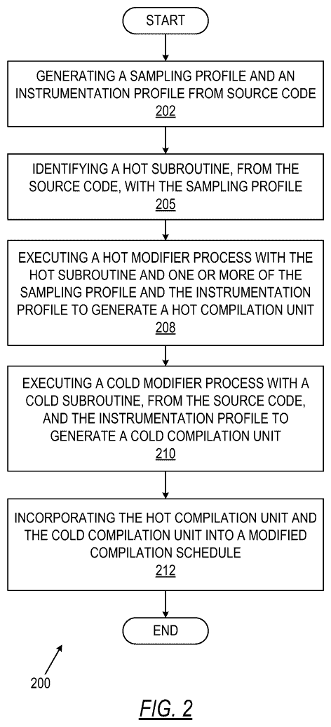

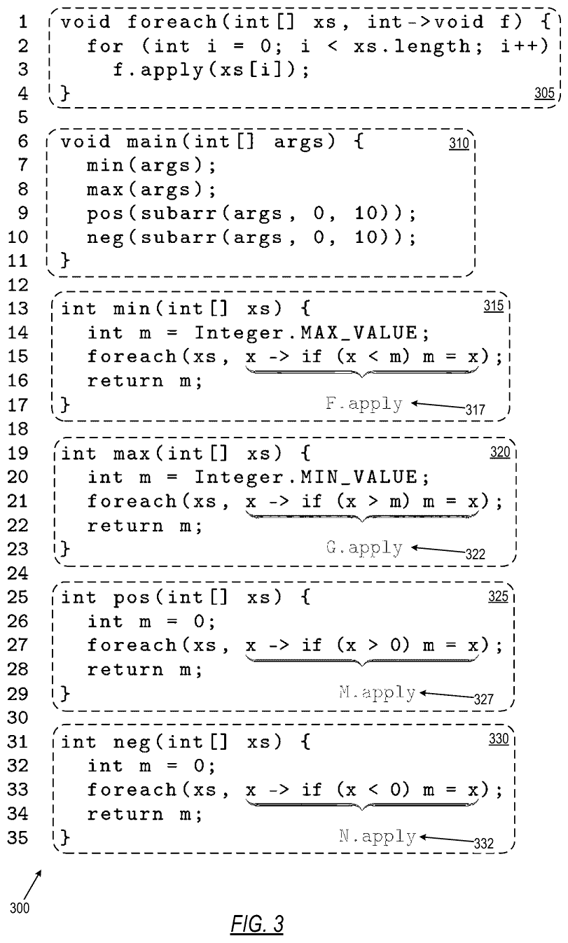

FIG. 2 shows a flowchart of a method of context-aware inlining based on hybrid profiling. The method of FIG. 2 may be implemented using the system of FIG. 1, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may perform context-aware inlining based on hybrid profiling. The process (200) may include multiple steps (e.g., steps (202) through (212)) that may execute on the components described in the other figures, including those of FIG. 1.

Step (202) includes generating a sampling profile and an instrumentation profile from source code. Generating the sampling profile and the instrumentation profile may involve compiling and executing the source code to collect run-time data. The sampling profile may be created by periodically capturing snapshots of the call stack of the program during execution, offering a context-sensitive view of the subroutine calls. The instrumentation profile may involve inserting code snippets into the source code to measure run-time properties and collect execution data such as event frequencies and behaviors of different parts of the code during execution.

Generating the sampling profile and the instrumentation profile may include generating a synthetic instrumentation profile from the sampling profile. The sampling profile may provide data that approximates the information gathered through instrumentation. Approximating the information instead of gathering the information through instrumentation may reduce the amount of resources used to generate profiles by foregoing the performance of instrumentation. The synthetic instrumentation profile may be derived by analyzing the frequency and patterns of subroutine calls recorded in the sampling profile, which may have less precision than instrumentation but also have less performance overhead.

Step (205) includes identifying a hot subroutine, from the source code, with the sampling profile. Identifying the hot subroutine may involve analyzing the sampling profile to determine which subroutines are frequently executed. The sampling profile may reveal subroutines that appear often in the call stack snapshots. The identified hot subroutines may be targeted for aggressive modification to enhance performance and reduce run time of modified executable code.

Identifying the hot subroutine may include comparing a sampling ratio to a hot threshold. The sampling ratio may include a combination of a number of samples from the sampling profile that contain the context and of a total number of samples from the sampling profile. The sampling ratio may be compared to a predefined hot threshold to decide if the subroutine is hot. The sampling ratio may be a percentage (e.g., five percent) of samples that include the subroutine in the specific context and may determine if the subroutine exceeds the hot threshold, indicating frequent execution. As an example, if the number of samples for a specific context divided by the total number of samples is greater than the hot threshold, the subroutine may be identified as hot.

Identifying a hot subroutine may include determining the hot subroutine is called via a direct call. The process may involve examining the structure of the call to the hot subroutine in the source code, or in the intermediate representation, or in the sampling profile to establish if the hot subroutine is invoked through a direct call rather than an indirect call. A direct call is one that is resolved at compile time and an indirect call is one that is resolved at run-time. In a sampling profile, a direct call may appear in a context as a fixed address or function name. An indirect call may appear in a context as a varying address or function name to reflect the dynamic resolution at run-time.

Identifying a hot subroutine may include duplicating the hot subroutine from a subroutine. The subroutine may be duplicated to create a specialized version for specific calling contexts. The duplication allows optimizations tailored to the context of the subroutine invocation, enhancing performance by creating context-specific compilation units.

Step (208) includes executing a hot modifier process with the hot subroutine and one or more of the sampling profile and the instrumentation profile to generate a hot compilation unit. The hot modifier process may be an optimizer component of a compiler. The hot modifier process may utilize one or more of the sampling profile and the instrumentation profile to apply aggressive modifications to the hot subroutine. The hot modifier process may execute one or more optimization techniques to modify the performance of the hot subroutine. The optimization techniques may include function inlining, loop unrolling, register allocation, low-level transformations, etc., that improve the performance of the hot subroutine. The hot compilation unit generated by the modification may have altered dependencies and may trigger modification to the compilation schedule. The hot modifier process may adjust the hot subroutine to improve execution efficiency, resulting in the hot compilation unit being modified for frequent execution contexts.

Executing the hot modifier process may include devirtualizing an indirect call in the hot subroutine to replace the indirect call with a direct call. The devirtualization process may transform an indirect method call into a direct call based on the context provided by the sampling profile. The replacement may reduce run time overhead and enhance performance by eliminating the need for dynamic method resolution. The benefit of replacing an indirect call to a hot subroutine with a direct call is that the run-time indirect call resolution does not need to be modified to include the duplicated versions of the hot subroutine. As a consequence, implementation may take less time and the resulting binaries may be smaller and faster.

Executing the hot modifier process may include executing the hot modifier process with an aggressive threshold. The aggressive threshold may be used to apply more extensive modifications to the hot subroutine as compared to the use of a conservative threshold. As an example, an aggressive threshold may allow optimizations that increase execution speeds and binary size, whereas a conservative threshold may allow only optimizations that increase execution speed if there is no binary size increase. The inlining budget may be increased (by reducing the value of the aggressive threshold as compared to the conservative threshold), for the compiler to modify the hot subroutines more effectively. Modifications may include polymorphic inlining and devirtualization resulting in less frequent indirect calls.

Executing the hot modifier process may include detecting recursion within the hot subroutine. Detection of recursion may involve identifying calls within the subroutine that refer back to the same subroutine, either directly or indirectly. Detection is used to handle recursive subroutines to avoid redundant modifications.

Executing the hot modifier process may include preventing recursive duplication using a recursion threshold. Preventing recursive duplication involves limiting the number of times a recursive subroutine is duplicated. The duplication may be limited with a recursion threshold (e.g., 3) that limits the number of levels of recursion that may be allowed. For example, a subroutine in a fourth level of recursion may not be duplicated when the recursion threshold is 3. Reusing existing duplicates after a certain number of recursions avoids unnecessary code bloat to maintain efficient performance.

Executing the hot modifier process may include executing the hot modifier process with the sampling profile and the synthetic instrumentation profile. The synthetic instrumentation profile may be generated from the sampling profile to approximate the information typically gathered through instrumentation. The hot modifier may utilize the sampling profile and the synthetic instrumentation profile to apply context-sensitive optimizations without the overhead of full instrumentation.

Executing the hot modifier process may include executing the hot modifier process with the sampling profile and with the instrumentation profile. The hot modifier may utilize both the sampling profile and the instrumentation profile to leverage context-sensitive data from the sampling profile and precise execution data from the instrumentation profile.

Step (210) includes executing a cold modifier process with a cold subroutine, from the source code, and the instrumentation profile to generate a cold compilation unit. The cold modifier process may be an optimizer component of a compiler. The cold subroutine may be processed using the instrumentation profile to apply conservative modifications to reducing size without significantly impacting performance. The cold modifier process may analyze run-time data to identify less frequently executed subroutines and apply modifications that prioritize reducing code size over performance improvements.

Executing the cold modifier process may include executing the cold modifier process with a conservative threshold. The conservative threshold may reduce the extent of modifications for minimal impact on execution time while reducing binary size. The process may involve less aggressive inlining and optimization techniques.

Step (212) includes incorporating the hot compilation unit and the cold compilation unit into a modified compilation schedule. The modified compilation schedule may combine the aggressively optimized hot compilation units and the conservatively optimized cold compilation units. The schedule may detail the order and manner of compiling the units to form the modified executable code. To incorporate the hot compilation unit and the cold compilation unit into a modified compilation schedule, the compiler may analyze dependencies between compilation units (including the hot compilation unit and the cold compilation unit) and determine which compilation units may be processed in parallel or sequentially.

The process (200) may further include generating modified executable code for the source code with the modified compilation schedule. The modified executable code may be generated from the modified compilation schedule by processing the hot and code compilation units in the order specified in the modified compilation schedule, with the compiler generating object code for each compilation unit according to the sequence of the schedule. A linker may then combine the object files generated from the compilation units to resolve cross-references and form the modified executable code.

The process (200) may further include executing the modified executable code. To execute, the modified executable code may be loaded into memory by an operating system that may set up an address space and load libraries. The operating system may create a process context and transfer control to an entry point of the modified executable code for the modified executable code to begin execution as defined by the source code while managing resources like memory, input output, system calls, etc. As the program runs, the processor executing the modified executable code fetches, decodes, and executes the modified instructions from the modified executable code to follow modified control flow paths that may have been introduced during the modification (i.e., optimization) process.

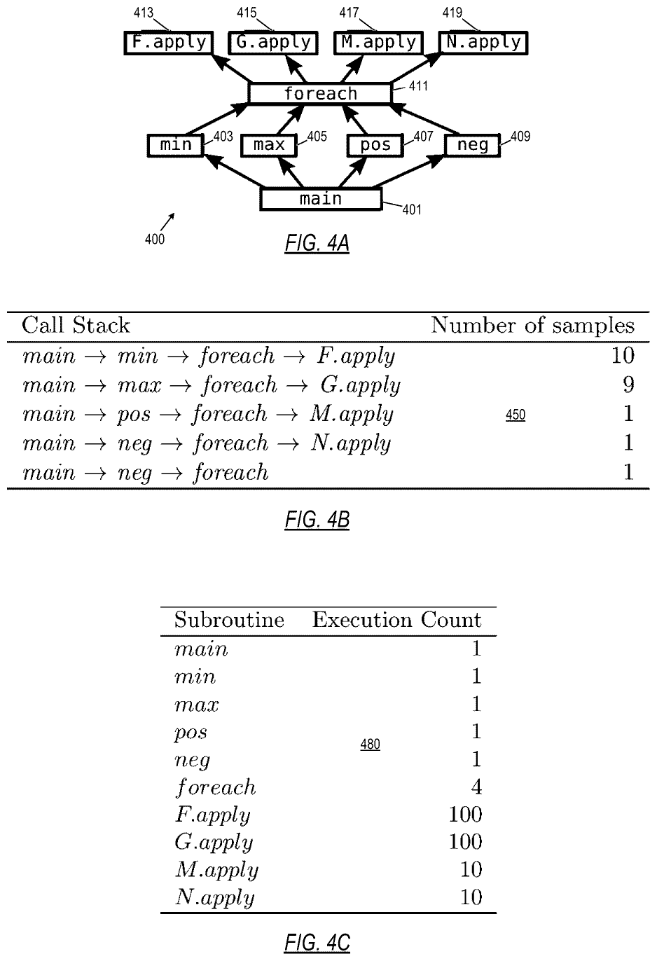

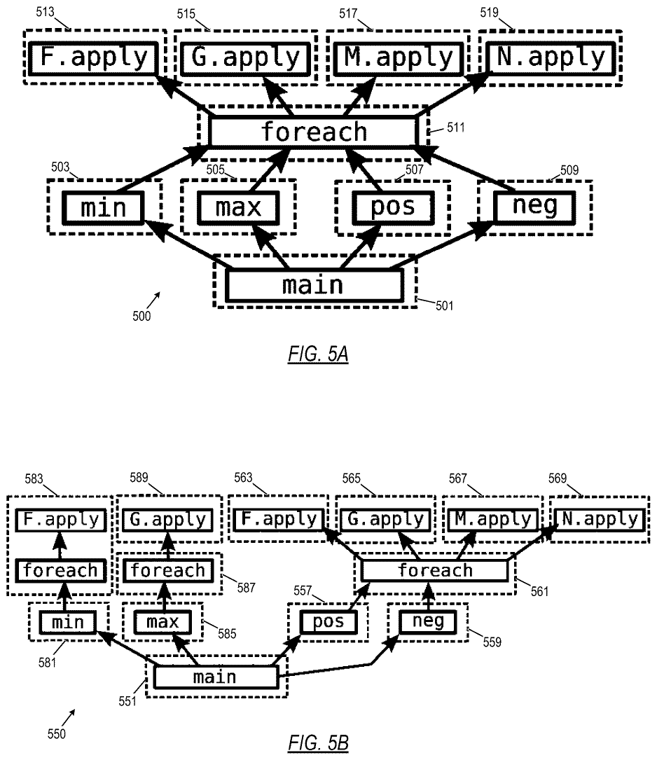

Turning to FIG. 3, the source code (300) illustrates an example of code that may be processed using context-aware inlining based on hybrid profiling. The example program performs four actions using the subroutines (305), (310), (315), (320), (325), and (330). The min subroutine (315) finds the smallest integer in a list of arguments. The max subroutine (320) finds the largest integer in a list of arguments. The pos subroutine (325) finds the last positive integer in a list of arguments. The neg subroutine (330) finds the last negative integer in a given list of arguments. Each of the action subroutines use the generic foreach subroutine (305), which iterates through a list and applies a function to each of its elements. When compiled and executed, the executable code starts from the main subroutine (310), which further calls each of min subroutine (315), the max subroutine (320), the pos subroutine (325), and the neg subroutine (330). The behavior of the foreach subroutine (305) is based on the arguments received when called, and therefore on the calling context. The labels (317), (322), (327), and (332), which may not be included in the source code (300) when compiled, identify the locations in the source code (300) that correspond to the nodes (413), (415), (417), and (419) of FIG. 4A for the lambda functions labeled as F.apply, G.apply, M.apply, and N.apply.

The foreach subroutine (305) of FIG. 3 contains an indirect call that may not be resolved during ahead of time (AOT) compilation without knowing the calling context of the invocation. When invoked from two out of the four possible calling contexts (i.e., from the pos and neg subroutines (325) and (330) of FIG. 3), the function argument is applied to a portion of the argument list. For the remaining two contexts (the min and max subroutines (315) and (320) of FIG. 3), the function is applied to a greater number of values, therefore, inlining F.apply and G.apply into the foreach subroutine, when invoked from min and max respectively, may lead to better optimizations in the foreach subroutine, and thus a faster version of the compiled program.

Turning to FIG. 4A, the call graph (400) may be generated from the source code (300) of FIG. 3. The call graph (400) includes the nodes (401) through (409). The node (401) represents the main subroutine (310) of FIG. 3. The node (403) represents the min subroutine (315) of FIG. 3. The node (405) represents the max subroutine (320) of FIG. 3. The node (407) represents the pos subroutine (325) of FIG. 3. The node (409) represents the neg subroutine (330) of FIG. 3. The node (411) represents the foreach subroutine (305) of FIG. 3. The node (413) represents the lambda function identified by the label (317) of FIG. 3. The node (415) represents the lambda function identified by the label (322) of FIG. 3. The node (417) represents the lambda function identified by the label (327) of FIG. 3. The node (419) represents the lambda function identified by the label (332) of FIG. 3. The edges between the nodes indicate calls between the subroutines represented by the nodes. The main subroutine (represented by the node (401)) calls the min, max, pos, and neg subroutines (represented by the nodes (403), (405), (407), and (409), respectively). The min, max, pos, and neg subroutines each call the foreach subroutine (represented by the node (411)). The foreach subroutine (represented by node (411)) calls the F.apply, G.apply, M.apply, and N.apply lambda functions (represented by the nodes (413), (415), (417), and (419), respectively).

Turning to FIG. 4B, the sampling profile (450) may be generated by sampling execution of the source code (300) of FIG. 3 after compilation. The column labeled “Call Stack” includes information that represents the call stack observed during execution. The column labeled “Number of samples” includes information that identifies the number of times a call stack was observed. The call stack value of “main→min→foreach→F.apply” was observed “10” times during execution of the program compiled from the source code (300) of FIG. 3. The call stack value of “main→max→foreach→G.apply” was observed “9” times. The call stack values of “main→pos→foreach→M.apply”, “main→neg→foreach→N.apply”, “main→neg→foreach” were each observed “1” time.

Turning to FIG. 4C, the instrumentation profile (480) may be generated by inserting instrumentation code into the source code (300) of FIG. 3 to gather statistics. The column labeled “Subroutine” includes information that identifies a subroutine that was included in the source code (300). The column labeled “Execution Count” includes information that identifies the number of times a subroutine was executed. From the instrumentation profile (480), the main, min, max, pos, and neg subroutines were each executed “1” time. The foreach subroutine was executed “4” times. The F.apply and G.apply lamda functions were each executed “100” times. The M.apply and N.apply lambda functions were executed “10” times.

Turning to FIG. 5A, the compilation schedule (500) (without modification, i.e., without optimizations) may be generated from the source code (300) of FIG. 3 and correspond to the call graph (400) of FIG. 4. The compilation units (501), (503), (505), (507), (509), (511), (513), (515), (517), and (519) respectively correspond to the nodes (401) through (419) of the call graph (400) of FIG. 4 and to respective subroutines from the source code (300) of FIG. 3. For example, the compilation unit (511) corresponds to the node (411) of FIG. 4 and to the foreach subroutine (305) of FIG. 3. Inlining did not occur when generating the compilation schedule (500) and each subroutine forms a separate compilation unit as noted by the dotted lines around each node.

Turning to FIG. 5B, the modified compilation schedule (550) may be generated from the source code (300) using hybrid profiling, e.g., using the sampling profile (450) of FIG. 4B and the instrumentation profile (480) of FIG. 4C. During the analysis using hybrid profiling, multiple subroutines are identified as hot subroutines, may be duplicated, and be included in multiple compilation units. For example, the foreach subroutine (305) of FIG. 3 may be identified as a hot subroutine, duplicated twice, and included in the compilation units (561), (583), and (587). The F.apply lamda function (corresponding to the label (317) of FIG. 3) may be identified as hot, duplicated once, and included in the compilation units (563) and (583). The G.apply lamda function (corresponding to the label (322) of FIG. 3) may be identified as hot, duplicated once, and included in the compilation units (565) and (589). The compilation units (551), (557), (559), (561), (563), (565), (567), and (569) may be similar to the compilation units (501), (507), (509), (511), (513), (515), (517), and (519) of FIG. 5A.

The compilation unit (583) is for the calling context “main→min→foreach→F.apply”. In the compilation unit (583), the F.apply lamda function is inlined into the foreach subroutine.

The compilation unit (589) is for the calling context “main→max→foreach→G.apply”. In the compilation unit (589), the G.apply lamda function is not inlined into the foreach subroutine that calls the G.apply lamda function so that there are two separate compilation units, the compilation unit (589) for the G.apply lamda function and the compilation unit (587) for the foreach subroutine that is called with the context of “main→max→foreach→G.apply”.

In the compilation scenario that generates the compilation schedule (550), two hot calling contexts for the foreach subroutine (305) of FIG. 3 and two cold ones are identified. The subroutine exhibits different behavior when invoked from each of these calling contexts. When a subroutine is compiled at most once per program, then compilation unit of the subroutine may capture each possible behavior. Therefore, the inlining algorithm may polymorphically inline none, one, or more of the concrete apply subroutines, based on heuristics. Not all indirect invokes may be inlined (nor would that be beneficial in general, because choosing the correct inlined version at run time has a computational cost).

With the compilation schedule (550), the foreach subroutine (305) of FIG. 3 may be compiled three times with the compilation units (561), (583), and (587). Twice for the calling contexts for the min and max subroutines (315) and (320) of FIG. 3, and once for the remaining calling contexts. The two hot compilations, for the compilation units (583) and (587), of the foreach subroutine (305) of FIG. 3 may be tagged (e.g., marked with yellow) to identify hot compilation. The cold compilation for the compilation unit (561) may also be tagged differently (e.g., marked with blue). The algorithm duplicates a subroutine for each hot calling context, and then compiles the duplicates (including the original) separately, using profiles for that specific calling context. In this example, the inliner may inline F.apply in the foreach instance that is called from min. Alternatively, the inliner may decide not to inline G.apply into the foreach instance that is called from max. In that case, G.apply is duplicated as well (and marked yellow) and compiled with context-specific profiles for that invocation. In the instance of foreach for the compilation unit (561), which may be considered the default, no inlining occurs. The version of the subroutine of the compilation unit (561) may be expected to execute infrequently, and may not have a significant impact on the performance of the program.

Turning to FIG. 6, the algorithm of the pseudocode (600) may be used to implement context-aware inlining based on hybrid profiling. Input to the algorithm includes a call graph G of the program, sampling profiles Πₛ and instrumentation profiles II ¿. Instrumentation profiles may be either context-insensitive or partially context-sensitive. Sampling profiles may be context-sensitive, generated from a multitude of snapshots of the run-time call stacks of the program. Output of the algorithm 600 includes the compilation schedule Σₙ for scheduling compilation units considered by the algorithm as hot, and the compilation schedule Σᵣ for the remaining compilation units.

A compilation unit is a subroutine that is being compiled along with all the subroutines inlined at their respective call sites. The two compilation schedules Eh and Ey may form a modified call graph of the program, in which some of the subroutines are fused into compilation units (due to inlining), and some of the subroutines are duplicated (to be specific to a calling context).

The pseudocode (600) may be high-level pseudocode that defines an example of the algorithm. The algorithm operates on two queue data structures (hotCompileQueue and coldCompileQueue), defined in lines 3 and 4 of the pseudocode. Initially, the hotCompileQueue contains the entry point as defined by the sampling profiles (Πₛ). The coldCompileQueue includes each of the entry points from the call graph, including the entry points found in the sampling profiles (Πₛ). The sampling profiles are context sensitive so the entry point may be the common root subroutine for the samples gathered for the profile. Programs may have multiple entry points, for the sake of simplicity a single entry point is described. The algorithm generalizes to multiple entry points by repeating the algorithm as described here for each entry point.

The algorithm iterates until the hotCompileQueue is empty (line 5). Most of the operations are performed on a single subroutine, taken (destructively) from the front of hotCompileQueue (lines 6 and 7). On line 8, the algorithm makes inlining decisions for the selected subroutine. The name of the inlining function is INLINEHOT, which is contrasted with INLINECOLD used later in the algorithm. The INLINEHOT function may be a more aggressive version on INLINECOLD, i.e. the same general operation but with a significantly increased budget.

The inlining optimization within the hot compilation units may use both sampling and instrumentation profiles. Sampling profiles may be used to decide whether to inline hot calls, and instrumentation profiles for the cold calls. The result of inlining is added to the output of the algorithm Σₕ (line 9).

After the inlining is performed at line 8, two additional sources of information are updated. The call sites in the compilation unit (line 10) and the full context of the root of the compilation unit, i.e. the subroutine (line 11).

A determination is made as to whether each of the call sites is hot or not (line 14) The decision is performed by the ISHOT function and is based on the callee subroutine s, the context (calleeContext declared in line 13), and the general sampling profiles Πₛ.

Callees that are deemed to be not hot are placed on the coldCompileQueue. Callees that are not hot are handled in the later steps of the algorithm (line 23).

The hot callees may be direct or indirect. The hot callees are handled in one of two ways based on whether being called directly or indirectly (line 15).

If the call is direct, the callee is duplicated (line 16) in order to create a subroutine that can be optimized fully context-dependently, i.e., the subroutine may be specialized for a particular context. The compilation unit is also updated to call the newly created subroutine instead of the original. The duplicate is added to the hotCompileQueue (line 17) to later be compiled as hot. The callee context for this subroutine is also added to the compilationContext map on line 18, so the context for which the subroutine should be specialized may be looked up later.

If the call is indirect, then the subroutine that will be invoked at run time may not be determined so that no duplication may be performed. The algorithm may devirtualize the call according to the sampling profiles at that particular context (line 20). The result of the devirtualization is a set of direct call sites to concrete subroutines, which the algorithm adds to the existing set of call sites to be considered for duplication.

After handling the hot subroutines, a similar approach for cold subroutines may be performed that may be simpler or not as aggressive. Handling the cold subroutines involves iterating until the coldCompileQueue is empty (line 27) and handling each subroutine in order (lines 28 and 29). For each subroutine, the algorithm performs the INLINECOLD operation (line 30), which, unlike INLINEHOT, relies on instrumentation profiles Πᵢ without relying on the sampling profiles Πₛ. The resulting compilation unit is added to the algorithm's output ¿y (line 31), and all the callees of the compilation unit are added to the cold CompileQueue (lines 32 and 33).

The algorithm of the pseudocode (600) may execute using the examples from the previous figures, including the source code of FIG. 3, the call graph (400) of FIG. 4A, the sampling profile (450) of FIG. 4B, and the instrumentation profile (480) of FIG. 4C, to generate the compilation schedule (550) of FIG. 5B. The inputs to the algorithm of the pseudocode (600) include the call graph (400) of FIG. 4A, the sampling profile (450) of FIG. 4B, and the instrumentation profile (480) of FIG. 4C. The steps of the algorithm may be executed described below.

At line 1 of the pseudocode (600), the compilation schedule Σₕ and Σᵣ are initialized.

At line 2 of the pseudocode (600), the compilation-context map is initialized to an initial mapping from the entry point (common root for all the samples in the profile) according to the sampling profiles to itself, i.e., main to [symbol] main [symbol] .

At lines 3 and 4 of the pseudocode (600), the compile queues are initialized. The hotCompileQueue is set to contain a the main subroutine as it is the entry point. The coldCompileQueue is set to be empty.

At line 5 of the pseudocode (600), the hotCompileQueue is not empty, so an iteration of the loop begins.

At lines 6 and 7 of the pseudocode (600), the first subroutine (i.e., main) from the hotCompileQueue is extracted. The hotCompileQueue is now empty.

At line 8 of the pseudocode (600), the inlining operation is performed on main, and the subroutine is treated as hot during inlining. For this example, the inlining operation does not actually inline any of the call sites from main.

At lines 9 and 10 of the pseudocode (600), since no call site was inlined into main, the list of call sites of that compilation unit is min, max, pos, and neg.

At line 11 of the pseudocode (600), the compilationRootContext is set to the compilation context of the subroutine, and since main is an entry point the context is [symbol] main [symbol] .

At line 12 of the pseudocode (600), the list of call sites is not empty so each is considered in a loop.

At line 13 of the pseudocode (600), the calleeContext for min is set to be [symbol] main, min [symbol] . This is because the compilationRootContext is main and the relative context of the call to min in main is just min itself (recall, that no inlining was done on main).

At line 14 of the pseudocode (600), the call to min is declared to be hot according to the sampling profiles since 10 of the 22 total samples include the call min from this context (i.e., [symbol] main [symbol] ).

At line 15 of the pseudocode (600), the call to min is a direct call, so the true branch of the if statement is taken.

At line 16 of the pseudocode (600), a duplicate of min is created. Let's call this duplicate min′. The compilation unit rooted in main is updated to call min′ instead of min.

At line 17 of the pseudocode (600), the subroutine min′ is added to the end of the hot CompileQueue.

At line 18 of the pseudocode (600), the compilation-context map is updated with the mapping from min′ to (main, min). With the mapping, the specific context for min′ may be looked up later in the algorithm.

Reiterating from line 12 of the pseudocode (600), a new iteration of the loop begins, this time considering the max subroutine. The same steps may be taken as for min, to create max′, updating the compilation unit rooted in main to call it, adding max′ to the hotCompileQueue and updating the compilation-context map to contain max′→ [symbol] main, max [symbol] . At this point, the hotCompileQueue contains min′ and max′ and both their contexts can be looked up in compilationContext.

Reiterating again from line 12 of the pseudocode (600), a new iteration of the loop begins to consider the pos subroutine. The pos subroutine is considered to not be hot according to the sampling profiles because 1 of the 22 total samples includes the call to pos at the context. The subroutine is added to the end of the coldCompileQueue.

Reiterating again from line 12 of the pseudocode (600), similar operations are performed in the next iteration with the neg subroutine. The coldCompileQueue contains pos and neg.

Reiterating back to line 5, since the call sites were processed, a new iteration of the outer loop begins. The content of the hotCompileQueue is now min′ and max′, so min′ is removed from the queue as the next subroutine to process.

At line 8 of the pseudocode (600), the inlining operation is performed on the min′, and the subroutine is treated as hot during inlining. For the discussion of this example, the inlining operation does not inline the calls from min′.

At line 10 of the pseudocode (600), the callee of the compilation unit rooted in min′ is the direct call to foreach.

At line 11 of the pseudocode (600), the compilation root context of the min′ subroutine is looked up from compilationContext and is main.

At line 12 of the pseudocode (600), one iteration of the loop over call sites sets the callee context of foreach to [symbol] main, min, foreach [symbol] .

At line 14 of the pseudocode (600), the call to foreach is deemed to be hot, since 10 of the 22 samples in the sampling profile include the call to foreach at this context.

At line 15 of the pseudocode (600), the call to foreach is a direct call, so the algorithm duplicates the subroutine creating foreachₘᵢₙ, updates the compilation unit to call foreachₘᵢₙ, adds foreachₘᵢₙ to the hotCompileQueue and adds the calleeContext of foreachₘᵢₙ to the compilationContext map.

Reiterating back to line 5 of the pseudocode (600), the next subroutine in the hotCompileQueue is max′. Similar steps are taken as during the processing of min′, so the result is the creation of the duplicate foreachₘₐₓ, updating the compilation unit rooted in max′ to call foreachₘₐₓ, adding foreachₘₐₓ to the hotCompileQueue and updating the compilation-context map to contain foreachₘₐₓ→ [symbol] main, max, foreach [symbol] . The hotCompileQueue contains foreachₘᵢₙ and foreachₘₐₓ and contexts for both may be looked up in compilationContext.

Reiterating back to line 5 of the pseudocode (600), a new iteration of the loop begins to consider the foreachₘᵢₙ subroutine.

At line 8 of the pseudocode (600), during the inlining for the foreachₘᵢₙ subroutine the sampling profiles are leveraged to devirtualize the indirect call to apply. From the sampling profiles for the context [symbol] main, min, foreach [symbol] the subroutine that is called is F.apply. The indirect call is transformed into a direct call to F.apply. The indirect call may remain as a backup. The inliner may inline the call to F.apply and no other callees are present in the compilation unit. The devirtualization is not the one shown in line 15 of the algorithm, but is rather a part of the INLINEHOT function. The devirtualization performed in line 8 may not be available to INLINECOLD, as INLINECOLD may not have access to sampling profiles.

At line 12 of the pseudocode (600), another iteration of the loop begins to consider the foreachₘₐₓ subroutine.

The inlining from the foreachₘₐₓ subroutine may not do the devirtualization to inline the apply call. Not performing the devirtualization may be due to the inlining operation being limited by a budget. The effect is that the callees of the resulting compilation unit may include an indirect call to apply.

At line 14 of the pseudocode (600), this call is determined to be hot according to the sampling profiles (9 out of 22 samples), and its calling context is [symbol] main, max, foreach, apply [symbol] .

At line 15 of the pseudocode (600), the call is not direct, so the algorithm proceeds to devirtualize the call according to the callee context and the sampling profiles (line 20). Similarly to the devirtualization during inlining of foreachₘᵢₙ, a direct call to G.apply results, which is added to the list of call sites to be processed later in the same for loop.

Reiterating back to line 12 of the pseudocode (600), the call to G.apply is the next callee considered and the callee calling context is [symbol] main, max, foreach, apply [symbol] .

At line 15 of the pseudocode (600), the call has the same context as the indirect call to apply considered in the last iteration so the call to G.apply is considered hot for the same reason.

At line 16 of the pseudocode (600), the call to G.apply is a direct call so the call to G.apply is duplicated, creating G.apply′, adding G.apply′ to the hotCompileQueue, and adding the callee context of G.apply′ to the compilationContext map.

Reiterating again back to line 12 of the pseudocode (600), in a final iteration, G.apply′ is taken off the queue to be considered. Since G.apply′ has no callees to inline or duplicate and since the hotCompileQueue is empty the loop terminates.

At line 27 of the pseudocode (600), the algorithm now proceeds to iterate until the coldCompileQueue is empty. The coldCompileQueue contains pos and neg.

At lines 28 through 30 of the pseudocode (600), the first subroutine (i.e., pos) is taken off the queue and inlining is performed on it. Note that this is the INLINECOLD function which operates with less budget and no sampling profiles. For this example, no inlining happens.

At lines 32 through 33 of the pseudocode (600), the call sites of pos are placed on the coldCompileQueue, which is a call to foreach.

Reiterating back to line 27 of the pseudocode (600), the first subroutine (neg) is taken off the queue and inlining is performed. For this example, no inlining happens.

At lines 32 through 33 of the pseudocode (600), the call sites of neg are placed on the coldCompileQueue. The call sites include a call to foreach which is already on the queue, so this is a no-effect operation.

Reiterating again back to line 27 of the pseudocode (600), in the next iteration, the first subroutine (foreach) is taken off the queue and inlining is performed on it. For this example, no inlining happens.

At lines 32 through 33 of the pseudocode (600), all the callees of foreach are placed on the coldCompileQueue, which include the indirect apply call, which schedules each of the implementations of apply to ensure each possible implementation is compiled. Here, F.apply, G.apply, M.apply and N.apply are placed on the coldCompileQueue.

Reiterating again back to line 27 of the pseudocode (600), none of apply subroutines have calls to inline or schedule and the algorithm processes the apply subroutines one by one with no significant change. The algorithm terminates thereafter.

An aspect of the disclosure is the ability to distinguish which subroutines are considered hot and which are not. The determination is performed on the basis of sampling profiles, which are context-sensitive. The context sensitivity allows the algorithm to make the hot/cold distinction in a context-aware manner, i.e., one subroutine may be considered hot in one context but cold in another. An example with the foreach subroutine (305) of FIG. 3, which is treated as both hot and cold in different contexts.

A particular subroutine is considered hot at a particular context if the total number of samples containing that context followed by that subroutine, as a percentage of the total number of samples, exceeds a certain threshold E, as shown in Equation 1.

$$IsHot ( s , 〈 {s}_{0} , {s}_{1} , … {s}_{m} 〉 ) = \frac{\vert \{ π ∈ {Π}_{s} : π = 〈 {s}_{0} , s , … , {s}_{m} , s , … , {s}_{n} 〉 \} \vert}{\vert {Π}_{s} \vert} \geq ε \qquad ( 1 )$$

Consider the sampling profile (450) of FIG. 4B and the question whether the subroutine max at the context (main, max) is hot. 9 samples out of 22 contain the (main, max) context, which is approximately 41% of the total samples. A value for ε (the hot threshold) used in practice may be 5% (other values may be used). The hot threshold of 5% is satisfied by the sample percentage of 41% to conclude that the subroutine max at the context (main, max) is hot.

Another aspect of the disclosure for hot subroutines is the ability to perform devirtualization of indirect call sites based on sampling profiles. Devirtualization is the process of replacing an indirect call with one or more direct calls according to provided profiles. As an example, the call to apply from foreachₘᵢₙ is devirtualized to a direct call to F.apply. On hot subroutines devirtualization may be done based on sampling profiles. The sampling profiles show which concrete subroutines are executed at particular contexts, as well as how likely each subroutine is to be executed.

Equation 2 below shows a function defining the possible subroutines that, according to the sampling profiles, may be invoked at a particular calling context. The possible subroutines are the set of subroutines s for which exist a sample in the sampling profiles such that the given context is a prefix of the sample, and the subroutine s is the next entry in the sample. A sample is an ordered list of subroutines observed on the call stack at run time. Equation 3 shows how to calculate the likelihood for each subroutine from Equation 2. The likelihood is a real number showing the ratio of how many samples contain the given subroutine s at that context and the total number of samples prefixed by the given context.

Equation 4 below shows the information used for devirtualization based on sampling profiles. The information is a set of pairs (s, l) where s is all the SAMPLEDCALLEES at that context, and/is how LIKELY each of those subroutines is.

$$SAMPLEDCALLEES ( 〈 {s}_{0} , {s}_{1} , … , {s}_{n} 〉 ) = \{ s : ∃ 〈 {s}_{0} , {s}_{1} , … , {s}_{n} , s 〉 ∈ {Π}_{s} \} \qquad ( 2 )$$

$$LIKELY ( 〈 {s}_{0} , {s}_{1} , … , {s}_{n} 〉 , s ) = \frac{\vert \{ π ∈ {Π}_{s} : π = 〈 {s}_{0} , {s}_{1} , … , {s}_{n} , s , … 〉 \} \vert}{\vert \{ π ∈ {Π}_{s} : π = 〈 {s}_{0} , {s}_{1} , … , {s}_{n} 〉 \} \vert} \qquad ( 3 )$$

$$DEVIRTPROFILE ( context ) = \{ ( s , l ) \vert \begin{matrix}s ∈ SAMPLEDCALLEES ( context ) ∧ \\ l = LIKELY ( context , s )\end{matrix} \} \qquad ( 4 )$$

Precise devirtualization is not possible with context insensitive profiles such as instrumentation profiles. Precise devirtualization is not possible because, in instrumentation profiles, each of the profiles are merged into one set of context-insensitive profiles (or partially context-sensitive profiles). The merge precludes the ability to eliminate the subroutines that may not be invoked at the current context. In other words, a fully-context-sensitive profile may be more precise than a partially context-sensitive profile, or a context-insensitive profile.

Another aspect of the disclosure is duplicating hot subroutines. To specialize the compilation of a subroutine depending on the calling context of the subroutine, the ability to perform duplication of a subroutine may be used. Duplication may be done a multitude of ways, from source code duplication to duplication of the intermediate representation (IR). The duplication should not modify the subroutine, as its role is only to provide a duplicate that other optimizations, primarily inlining, can specialize for a particular context. Acceptable modifications that may be applied to the duplicated subroutine is a context-specific update of the profiles used to optimize the subroutine. An example is the update to profile information on concrete subroutine implementations at indirect calls. Since the duplicate is bound to a particular context, the information may be updated safely to reflect the profile as seen in the sampling profiles at that context. Duplication improves further inlining decisions as well as opens new optimization opportunities that depend on more accurate profiling information.

When other kinds of profiles may be inferred or predicted from the sampling profiles, the inferred profiles may be applied to duplicate methods in a context-sensitive manner. As one example of inferring other kinds of profiles, if the sampling profiles contain information about the current position in the code (either in machine-level instruction pointer (IP) form, or a more high-level source-code-position form), then the information may be used to estimate the branch profiles, which an optimizing compilers may use in other optimization phases.

Another aspect of the disclosure is inlining hot subroutines. The INLINEHOT procedure from the pseudocode (600) may perform the inlining optimization within a hot compilation unit using an increased optimization budget, i.e., the algorithm performs the inlining more aggressively. Inlining can be considered a type of cost-benefit analysis and being “more aggressive” means trading more cost for less benefit.

Inlining may use both kind of profiles, sampling and instrumentation, to inline callees on hot and cold callsites, respectively. However, for the hot callsites sampling profiles may primarily be used to perform context-specific devirtualization and more precise inlining by giving a benefit boost to other hot subroutines. The numerical value of the increase in benefit may be based on the type of cost-benefit analysis and the type of numerical model.

An advantage of the context-aware inlining is that context-aware inlining may implicitly, through handling inlining differently on hot and cold subroutines, prioritize optimizing more important parts of the code more aggressively. A small part of the total code may be where most of the time is spent, so optimization of the small parts of the code may yield useful performance improvements.

Context-aware inlining allows the compiler to focus more heavily on higher used portions of the code to yield performance benefits, while being more conservative on lesser used portions of the code to still reduce the size of the resulting binary with minimal or no loss in performance.

For example, a cost-model may define callsite-exploration priority (which determines the order in which the call-tree is explored) as:

$$P ( n ) = \frac{{B}_{L} ( n )}{C ( n )} - ψ ( n ) \qquad ( 5 )$$

where B_{L}(n) is the perceived benefit of inlining the node n, C(n) is the perceived cost of inlining the node (modeled as a size of the intermediate representation (IR)) and ψ(n) is the penalty defined as follows:

$$ψ ( n ) = {p}_{1} \cdot {S}_{ir} \qquad ( 6 )$$

where Sir is the sum of the IR sizes in the respective subtree, and p₁ is a tunable weight. A slightly modified callsite-exploration priority formula may be used:

$$P ( n , context , {Π}_{s} ) = \frac{{B}_{L} ( n )}{C ( n )} - ψ ( n ) + {b}_{1} \cdot LIKELY ( subroutine ( n ) , context , {Π}_{s} ) \qquad ( 7 )$$

Equation 7 includes an additional tunable weight (b₁) which represent a bonus given to a priority of a node. The bonus may be scaled according to how LIKELY (as seen in Equation 3) the subroutine is, represented by the node.

Furthermore, when deciding whether to inline a cluster of methods M into the compilation unit C, the following formula may be used.

$$\frac{{\sum }_{n ∈ M} {B}_{L} ( n )}{{\sum }_{n ∈ M} {S}_{ir} ( n )} \geq Δ \qquad ( 8 )$$

Equation 8 has that the cumulative benefit of inlining a cluster divided by the cumulative cost of the cluster is greater than a threshold A. The threshold may be calculated dynamically based on multiple of factors.

Similarly to the approach of boosting the callsite-exploration priority, a boost may be given to the benefit of inlining hot subroutines. The boost may be achieved by introducing another tunable weight b₂ which may also be scaled, accordingly, based on sampling profiles. A difference is that the bonus from b₂ is applied to the sum of all benefits when deciding whether to inline, as shown in the following formula.

$$\frac{{\sum }_{n ∈ M} {B}_{L} ( n ) + {b}_{2} \cdot LIKELY ( root ( M ) , context , {Π}_{s} )}{{\sum }_{n ∈ M} {S}_{ir} ( n )} \geq Δ \qquad ( 9 )$$

Another aspect of the disclosure includes inlining on cold subroutines. The INLINECOLD procedure performs the inlining optimization within a cold compilation unit. In cold compilation units, the inliner does far less call-tree exploration and far less inlining than in the INLINEHOT counterpart. In the “cost-benefit” view of inlining, the inlining of the INLINECOLD procedure is more conservative, i.e., not willing to suffer much cost for a given benefit.

An advantage of using the INLINECOLD procedure on cold code is that, since the cold code is not executed often during run-time, the compiler may produce smaller binaries without the risk of performance degradation. The conservative approach of the INLINECOLD procedure may be achieved by removing or reducing the use of many types of compiler optimizations. For example, the use of duplication based optimizations such as loop unrolling, loop inversion, path duplication, loop peeling, loop unswitching, etc., may be reduced. The use of other optimizations, including vectorization, conditional elimination, global value numbering, partial escape analysis, double-read elimination, code motion on memory reads, speculative guard movement, etc., may also be reduced.

Since cold compilations are not context-specific, the algorithm may utilize instrumentation profiles to guide its decisions. The use of instrumentation profiles ensures that these subroutines behave correctly and are performant for the contexts from which the subroutines may be invoked.

Another aspect of the disclosure may include handling recursion. For simplicity, the previous examples did not describe recursion. The algorithm of the pseudocode (600) may operate on recursive subroutines, but may lead to increased duplication (due to recursion), which may negatively impact binary size without a performance benefit. In particular, the algorithm eventually terminates, because each recursive call has less samples than its caller. Having less samples than the caller means that the & value from Equation 1 is eventually reached.

To handle recursive subroutines, the recursive subroutines are first detected. Both direct (a subroutine that calls itself) and indirect (a subroutine that calls one or more different subroutines which eventually call the recursive one) may be appropriately handled.

The sampling profiles are fully context-sensitive, so that detecting recursive subroutines may be executed by processing each sample and finding the repeating subroutines. The process of identifying repeating subroutines may also identify the recursive subroutines that execute often, to be handled accordingly.

Recursive subroutines may be handled in multiple ways. The approaches described here build on top of each other, and no approach may be the best for each case. Each approach has strengths and weaknesses based on the run time behavior of the recursive subroutine.

One approach includes tracking the number of recursive duplications. One way to prevent overly aggressive duplication of recursive subroutines is to specify the number of times a recursive subroutine may be duplicated. A parameter D may be given to the algorithm and the algorithm may track the number of duplicates created for a recursive subroutine in the current context. When deciding whether to duplicate a recursive subroutine, the algorithm uses the parameter D, and if the number of duplicates exceeds the parameter D, the algorithm may decide to not duplicate any further and treat further recursive calls as cold code, as shown in the equation below.

$${IsHOT}_{rec} ( 〈 {s}_{0} , {s}_{1} , … , {r}_{0} , … , {r}_{m} 〉 ) = m < D ∧ {r}_{0} = {r}_{1} = … = {r}_{m} \qquad ( 10 )$$

While preventing unwanted binary size increase, a downside is that at one point during the execution of the recursive subroutine, the executing code may be conservatively compiled code. Executing conservatively compiled code may have a negative impact on performance if D is less than the number of recursions of the subroutine. The value for D that is provided may impact the performance of the compiled code.

Tracking recursive duplication may be extended by the reuse of recursive duplicates. The downside of tracking recursive duplication may be mitigated by combining the tracking of recursive duplication with the reuse recursive duplicates. The reuse recursive duplicates includes detecting that the number of duplications of a recursive subroutine is larger than D, and deciding not to duplicate. However, rather than treating the remaining recursions as cold code, the last recursive call (the one where duplication terminated) may be replaced with a call to a previously duplicated subroutine. The replacement provides that, no matter how deep the recursion is, the recursive code will be treated as hot.

The reuse of the recursive duplicate may not utilize full context-sensitivity. If the behavior of the subroutine changes depending on the depth of the recursion (e.g., calling different concrete implementations on indirect calls) the performance of code compiled may not be ideal. The duplicate may be specific to the context of a shallow recursion, but it is being reused for all depths of recursion.

Another approach includes context-insensitive reuse of recursive duplicates. Context-insensitive reuse may compile specific recursive duplicates that may be reused in a context-insensitive manner after the recursion is terminated. A particular subroutine detected as a duplicate may be reused (which is possible since sampling profiles and the maximum allowed recursion depth for duplication D are known ahead of time). The compilation of the specific subroutine may use instrumentation profiles, or a processed version of the sampling profiles where the call stacks above the current context are “flattened” to be merged into a context-insensitive version. The recursive subroutine, in this case, may have adequate performance independent of the recursion depth, since the reused duplicate behaves, on average, the same at all recursion depths.

To handle recursion, the algorithm may use the FOLDEDDEVIRTPROFILE function of Equation 11, which may be a modified version of the DEVIRTPROFILE function as defined in Equation 4.

$$FOLDEDDEVIRTPROFILE ( context ) = \{ \begin{matrix}( s , l ) \vert s ∈ SAMPLEDCALLEES ( context ) ∧ \\ l = RECURSIVELIKELY ( context , s )\end{matrix} \} \qquad ( 11 )$$

The FOLDEDDEVIRTPROFILE function includes the calculation of how likely a subroutine is, with the RECURSIVELIKELY function, defined in Equation 12.

$$RECURSIVELIKELY ( 〈 {s}_{0} , {s}_{1} , … , {s}_{n} 〉 , s ) = \frac{\vert \{ π ∈ {Π}_{s} : π = 〈 {s}_{0} , {s}_{1} , … , {s}_{n} , … s , … 〉 \} \vert}{\vert \{ π ∈ {Π}_{s} : π = 〈 {s}_{0} , {s}_{1} , … , {s}_{n} , … 〉 \} \vert} \qquad ( 12 )$$

The RECURSIVELIKELY function has that the profile in the numerator is not limited to the exact context. The “ . . . ” between sₙ and s in the numerator denotes that the recursive subroutine s may appear anywhere on the sample call stack.

Another aspect of the disclosure includes inferring instrumentation profiles from sampling profiles. The algorithm of the pseudocode (600) uses instrumentation profiles for handling context-insensitive situations (e.g., cold subroutines). Instrumentation profiles may have the advantage of being precise by not being dependent on timings of events during execution and are based on specific run-time execution of the program. Gathering instrumentation profiles may impact run-time performance of the instrumented application (i.e., the code compiled with instrumentation snippets), which may frustrate the generation of instrumentation profiles.

The sampling profiles may be used to approximate the instrumentation profiles to preclude the impact on run-time performance of the instrumented code. For example, the number of times a subroutine was invoked may be approximated by using the total number of times the subroutine appears in the sampling profiles. While not precise, the approximation may act as a proxy to prevent the gathering of an instrumentation profile to reduce the compile time of the program from the source code.

As another example, sampling profiles may be used to estimate conditional profiles. If the sampling profiles, at each stack frame, contain current position in the code (either in machine-level instruction pointer (IP) form, or in a high-level source-code-position form), then the current position information may be used to estimate branch profiles.

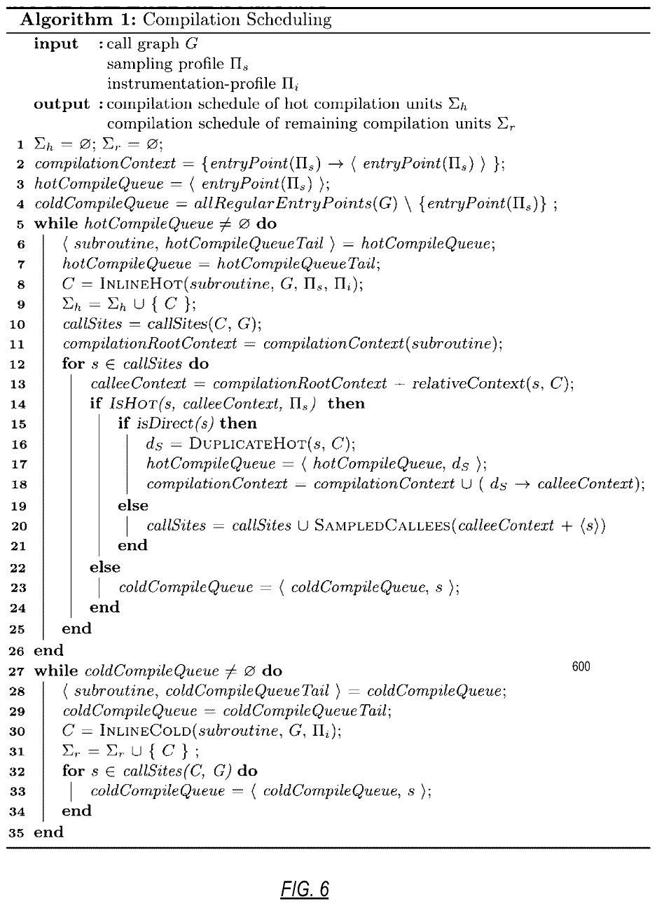

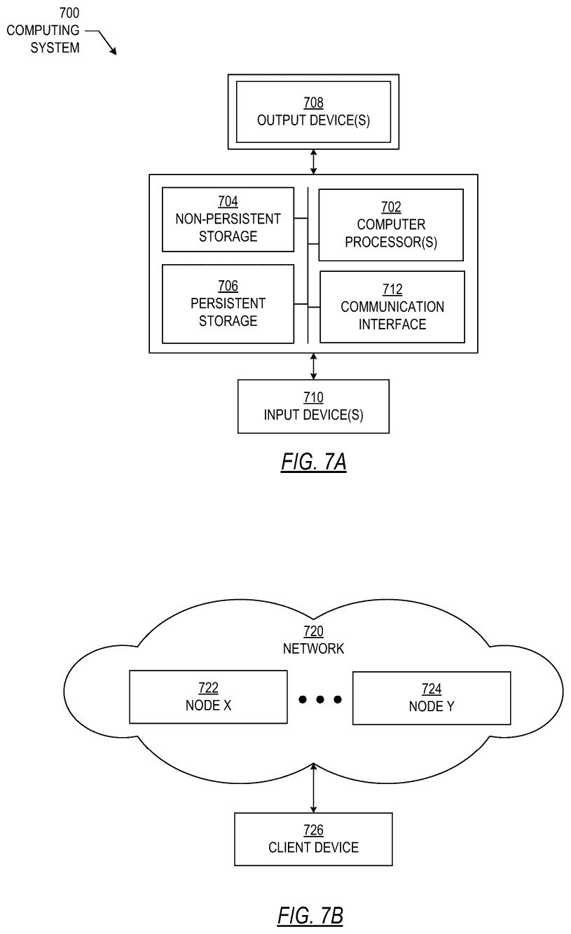

Embodiments may be implemented on a special purpose computing system specifically designed to achieve the improved technological result. Turning to FIGS. 7A and 7B, the special purpose computing system (700) may include one or more computer processors (702), non-persistent storage (704), persistent storage (706), a communication interface (712) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores or micro-cores of a processor. The computer processor(s) (702) includes one or more processors. The one or more processors may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responsive to data and messages presented by the output device(s) (708). The inputs may include text input, audio input, video input, etc., which may be processed and transmitted by the computing system (700) in accordance with the disclosure. The communication interface (712) may include an integrated circuit for connecting the computing system (700) to a network (not shown) (e.g., a local area network (LAN), a wide area network (WAN) such as the Internet, mobile network, or any other type of network), and/or to another device, such as another computing device.

Further, the output device(s) (708) may include a display device, a printer, external storage, or any other output device. One or more of the output device(s) (708) may be the same or different from the input device(s) (710). The input device(s) (710) and the output device(s) (708) may be locally or remotely connected to the computer processor(s) (702). Many different types of computing systems exist, and the aforementioned input device(s) (710) and output device(s) (708) may take other forms. The output device(s) (708) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (700) in FIG. 7A may be connected to or be a part of a network. For example, as shown in FIG. 7B, the network (720) may include multiple nodes (e.g., node X (722) and node Y (724)). Each node may correspond to a computing system, such as the computing system (700) shown in FIG. 7A, or a group of nodes combined may correspond to the computing system (700) shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726), including receiving requests and transmitting responses to the client device (726). For example, the nodes may be part of a cloud computing system. The client device (726) may be a computing system, such as the computing system (700) shown in FIG. 7A. Further, the client device (726) may include and/or perform all or a portion of one or more embodiments of the disclosure.

The computing system (700) of FIG. 7A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
generating a sampling profile and an instrumentation profile from source code;
identifying a hot subroutine, from the source code, with the sampling profile;
executing a hot modifier process with the hot subroutine and one or more of the sampling profile and the instrumentation profile to generate a hot compilation unit;
executing a cold modifier process with a cold subroutine, from the source code, and the instrumentation profile to generate a cold compilation unit; and
incorporating the hot compilation unit and the cold compilation unit into a modified compilation schedule.

2. The method of claim 1, further comprising:
generating modified executable code for the source code with the modified compilation schedule; and
executing the modified executable code.

3. The method of claim 1, wherein identifying the hot subroutine comprises:
determining the hot subroutine at a context when a number of samples from the sampling profile that contain the context compared to a total number of samples from the sampling profile satisfies a hot threshold.

4. The method of claim 1, wherein executing the hot modifier process comprises:
devirtualizing an indirect call in the hot subroutine to replace the indirect call with a direct call.

5. The method of claim 1, wherein identifying the hot subroutine comprises:
determining the hot subroutine is called via a direct call; and
duplicating the hot subroutine from a subroutine.

6. The method of claim 1, wherein executing the hot modifier process comprises:
executing the hot modifier process with an aggressive threshold.

7. The method of claim 1, wherein executing the cold modifier process comprises:
executing the cold modifier process with a conservative threshold.

8. The method of claim 1, wherein executing the hot modifier process comprises:
detecting recursion within the hot subroutine; and
preventing recursive duplication using a recursion threshold.

9. The method of claim 1,
wherein generating the sampling profile and the instrumentation profile comprises:
generating a synthetic instrumentation profile from the sampling profile, and wherein executing the hot modifier process comprises:
executing the hot modifier process with the sampling profile and the synthetic instrumentation profile.

10. The method of claim 1, wherein executing the hot modifier process comprises:
executing the hot modifier process with the sampling profile and with the instrumentation profile.

11. A system comprising:
at least one computer processor; and
an application that, when executing on the at least one computer processor, performs operations comprising:
generating a sampling profile and an instrumentation profile from source code,
identifying a hot subroutine, from the source code, with the sampling profile,
executing a hot modifier process with the hot subroutine and one or more of the sampling profile and the instrumentation profile to generate a hot compilation unit,
executing a cold modifier process with a cold subroutine, from the source code, and the instrumentation profile to generate a cold compilation unit, and
incorporating the hot compilation unit and the cold compilation unit into a modified compilation schedule.

12. The system of claim 11, further comprising:
generating modified executable code for the source code with the modified compilation schedule; and
executing the modified executable code.

13. The system of claim 11, wherein identifying the hot subroutine comprises:
determining the hot subroutine at a context when a number of samples from the sampling profile that contain the context compared to a total number of samples from the sampling profile satisfies a hot threshold.

14. The system of claim 11, wherein executing the hot modifier process comprises:
devirtualizing an indirect call in the hot subroutine to replace the indirect call with a direct call.

15. The system of claim 11, wherein identifying the hot subroutine comprises:
determining the hot subroutine is called via a direct call; and
duplicating the hot subroutine from a subroutine.

16. The system of claim 11, wherein executing the hot modifier process comprises:
executing the hot modifier process with an aggressive threshold.

17. The system of claim 11, wherein executing the cold modifier process comprises:
executing the cold modifier process with a conservative threshold.

18. The system of claim 11, wherein executing the hot modifier process comprises:
detecting recursion within the hot subroutine; and
preventing recursive duplication using a recursion threshold.

19. The system of claim 11,
wherein generating the sampling profile and the instrumentation profile comprises:
generating a synthetic instrumentation profile from the sampling profile, and wherein executing the hot modifier process comprises:
executing the hot modifier process with the sampling profile and the synthetic instrumentation profile.

20. A non-transitory computer readable medium comprising instructions executable by at least one computer processor to perform:
generating a sampling profile and an instrumentation profile from source code;
identifying a hot subroutine, from the source code, with the sampling profile;
executing a hot modifier process with the hot subroutine and one or more of the sampling profile and the instrumentation profile to generate a hot compilation unit;
executing a cold modifier process with a cold subroutine, from the source code, and the instrumentation profile to generate a cold compilation unit; and
incorporating the hot compilation unit and the cold compilation unit into a modified compilation schedule.
